(19) United States
(12) Patent Application Publication
(10) Pub. No.: US 2001/0051935 A1
(43) Pub. Date: Dec. 13, 2001

(54) Schedule reminder system

(75) Inventor: Atsushi Sugiura, Tokyo (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION

(21) Appl. No.: 09/874,262

(22) Filed: Jun. 6, 2001

(30) Foreign Application Priority Data
Jun. 7, 2000 (JP) 171094/2000

(51) Int. Cl. G06F 15/18

(52) U.S. Cl. 706/12

(57) ABSTRACT

In the step of executing an event of a schedule for each type of schedule, this schedule reminder system is provided with a database having information about whether to report what time a message that specifies the contents of work required for executing this event to a user. The schedule reminder system reports the message that specifies the contents of work required before the event occurs based on the database from schedule information entered by the user and the information about the date when the event occurs, to the user, as a message, when it is specified using the database.

### BACKGROUND OF THE INVENTION

1. Field of the Invention

The present invention is utilized for schedule management that gives to a user the instructions or the warning of work or the like to be executed in advance based on a schedule that the user has entered. The present invention is suitably utilized for a scheduler system that performs the schedule management of the user by the use of an information processor.

2. Description of Related Art

As schedule management systems that manage personal schedules, there are services that manage schedules by a PC client and manage the schedules on operating software and on an operating Web server, and for these systems, a reminder function has heretofore been realized.

The reminder function is a function for sending a message to a user by electronic mail or the like so that the user will not fail to notice a schedule event before the certain time from the time of an event or at a time indicated by the user when the user has entered the schedule event.

For example, when the user has entered “a regular meeting” as the schedule event and its date as “13:00 on May 15, 2000” in the schedule management system, the system reports to the user that the regular meeting will be held one hour after, by electronic mail before, for example, one hour (the user can specify this time) of the meeting.

Basically, one reminder is reported to the user for one schedule event, and the contents of the reminder to be reported are the contents themselves of the schedule event. Although there can be reported several times, the contents of the electronic mail to be sent to the user are always identical.

Further, there is an advertisement distribution system that has used electronic mail util now as another system which differs from a schedule management system having a reminder function. For example, a system that inserts an advertisement in addition to news articles corresponds to this system. This display example is shown in FIG. 4. The advertisement inserted here is identical to all the users, and the same advertisement is distributed over a fixed period.

Further, there is also a personalized advertisement system that changes an advertisement that is distributed every user. The advertisement that is distributed based on personal attributes (age, address, and sex distinction) and interest the user registered is determined here.

A conventional reminder function enables only notification of a reminder against a schedule event itself. However, according to a schedule event, another work is previously necessary toward the event and another work may be necessary after the event. For example, when you travel abroad, you need to reserve an air ticket and a hotel, and to make an application for your passport three weeks before. Further, when you have purchased a car, you must make a one-moth inspection and a six-month inspection after purchase. Although it is desirable for the user that not only the reminder of the schedule event but also a related work item be reported together, the conventional reminder function cannot perform such notification as described above.

Moreover, in a system that distributes an advertisement by electronic mail, since there are many unnecessary advertisements distributed in order to send the same advertisement to the plurality of users, and since the advertisement is described in a different area apart from news articles, the users frequently skip it, and, therefore, the advertisement will not always have high effect.

Even when an advertisement that is personalized according to personal attributes is inserted, the user's interest is merely estimated from age and sex distinction, and the possibility that the user can select the advertisement he or she requires is not always high. Even if the user directly registers his or her interest, the interest is not universal. Further, even in case of the personalized advertisement, contents and the advertisement are displayed in a different area.

### SUMMARY OF THE INVENTION

The present invention has been developed in such background, and an object of the present invention is to provide a schedule reminder system and a method that can describe a work item regarding a schedule event and reports a reminder to a user. Further, a further object of the present invention is to provide a schedule reminder system, an advertisement billing system, and a method that send a remind message containing an advertisement to a user, and charge them.

The schedule reminder system of the present invention is provided with a template table where events are classified in accordance with various types and that holds one or more sets of remind messages in which work items regarding schedule events are described and information about timing at which each message is reported to the user, said schedule reminder system comprising:

remind message registration means for acquiring the remind message and information about timing at which the message should be reported from a template file of the corresponding event type based on the schedule event and the date entered by the user, and for obtaining a time at which the remind message should be sent from the event date and the timing information to be reported; and

message sending means for sending the remind message to the user at a sending time obtained by this remind message registration means. Further, the schedule remind system comprises a message database that can hold information about a message sending time obtained by the remind message registration means and a plurality of combinations of the remind message and a receiving destination, wherein the message sending means can include means for sending a remind message to the user of the sending destination referring to this database.

Thus, since a plurality of different remind messages can be sent at a different time, a necessary work item and necessary information can be reported against a schedule event a user specified at an appropriate time, respectively, and a thorough remind service can be offered. Further, since the timing at which a message is reported can freely be set, reminding can also be performed concerning a later work item than the event date.

The present invention basically presupposes as the input of a user that a type and a date of an event are specified. However, it is originally desirable that the contents of the event can freely be described instead of the type of event. The present invention can also comprise event type selection means that samples a keyword from a character string a user freely described and automatically selects the event type which corresponds to the keyword. Consequently, the user can freely describe the contents of the event without specifying the event type.

Further, since the present invention can freely describe the contents of a remind message, it can describe the contents that correspond to an advertisement, in the message. Further, the identifier (ID) of the advertisement described in the remind message can be stored in the database together with the remind message. Furthermore, the present invention can comprise advertisement billing means that counts and registers the sending frequency for each advertisement ID when the remind message containing the advertisement was sent to a user.

Thus, every time a remind message is reported, an advertisement regarding an event entered by a user can be displayed. Since the advertisement is displayed based on the schedule of the user, personal interest can be estimated more accurately than a personalized advertisement that uses personal attributes of the user and a high effectiveness of advertising can be anticipated. Further, since an advertisement is contained in a message instead of being contained in an area that differs from the message, the probability at which a user recognizes the presence of the advertisement increases and a valid effectiveness of advertising can be anticipated. Further, since the frequency at which the advertisement was offered to the user is counted, advertising rates can be charged against an advertiser in accordance with the frequency of advertising.

Further, this invention can also use advertisement selection means that adds an advertisement to a message based on a keyword contained in a remind message. Accordingly, an advertisement can automatically be added later to the message, too, that is not contained in the advertisement.

In the message notification by the remind message notification means, the notification method, such as short messages using electronic mail, a facsimile system, and a cellular phone, will not be limited. Further, a remind message may also be displayed on a scheduler system calendar of the calendar format. Thus, the present invention can be used over a wide range without selecting terminals a user is using.

Such reminder system and method can also apply to client software that operates on only a client, or can also apply as server software by connecting a client terminal and a server a user uses via a network and arranging each component means in the server. The present invention can also be realized as a recording medium in which such software was recorded.

### BRIEF DESCRIPTION OF THE DRAWINGS

Specific embodiments of the present invention will now be described, by way of example only, with reference to the accompanying of drawings in which:

FIG. 1 is a block diagram of a scheduling reminder system according to a first embodiment of the present invention;

FIG. 2 is a drawing for describing a scheduling reminder system provided in a server;

FIG. 3 is a drawing for describing a scheduling reminder system provided in a client;

FIG. 4 is a drawing showing an example of advertisement distribution in which conventional electronic mail was used;

FIG. 5 is a drawing showing an example of user operation when a user uses a user interface and a system for the scheduling reminder system of the present invention;

FIG. 6 is a drawing showing an example of user operation when a user uses a user interface and a system for the scheduling reminder system of the present invention;

FIG. 7 is a drawing an example of a reminder message distributed to a user;

FIG. 8 is a drawing showing an example of a checklist template file according to the first embodiment of the present invention;

FIG. 9 is a drawing showing an example of a message database according to the first embodiment of the present invention;

FIG. 10 is a flowchart for describing the operation step of a remind message registration portion according to the first embodiment of the present invention;

FIG. 11 is a flowchart for describing the operation step of a message sending portion according to the first embodiment of the present invention;

FIG. 12 is a block diagram of a scheduling reminder system according to a second embodiment;

FIG. 13 is a drawing showing an example of a keyword versus checklist interrelation table according to the second embodiment of the present invention;

FIG. 14 is a flowchart for describing the operation step of a checklist selection module according to the second embodiment of the present invention;

FIG. 15 is a block diagram of a scheduling reminder system according to a third embodiment of the present invention;

FIG. 16 is a drawing showing an example of a checklist template file according to the third embodiment of the present invention;

FIG. 17 is a drawing showing an example of a message database according to the third embodiment of the present invention;

FIG. 18 is a drawing showing an example of a billing database according to the third embodiment of the present invention;

FIG. 19 is a flowchart for describing the operation step of a remind message registration portion according to the third embodiment of the present invention;

FIG. 20 is a flowchart for describing the operation step of a message sending portion according to the third embodiment of the present invention;

FIG. 21 is a flowchart for describing the operation step of a billing module according to the third embodiment of the present invention;

FIG. 22 is a block diagram of a schedule reminder system according to a fourth embodiment of the present invention;

FIG. 23 is a drawing showing an example of a keyword versus advertisement interrelation table according to the third embodiment of the present invention;

FIG. 24 is a flowchart for describing the operation step of a remind message registration portion according to the fourth embodiment of the present invention;

FIG. 25 is a flowchart showing the operation step of an advertisement portion according to the fourth embodiment of the present invention;

FIG. 26 is a drawing showing an example of a checklist template file according to the first embodiment of the present invention;

FIG. 27 is a drawing showing an example of a message database according to the first embodiment of the present invention;

FIG. 28 is a drawing showing an example of a keyword versus checklist interrelation table according to the second embodiment of the present invention;

FIG. 29 is a drawing showing an example of a checklist template file according to the third embodiment of the present invention;

FIG. 30 is a drawing showing an example of a message database according to the third embodiment of the present invention;

FIG. 31 is a drawing showing an example of a billing database according to the third embodiment of the present invention;

FIG. 32 is a drawing showing an example of a billing database according to the third embodiment of the present invention;

FIG. 33 is a drawing showing an example of a schedule event displayed on a calendar of a scheduler;

FIG. 34 is a block diagram of a schedule reminder system according to a fifth embodiment of the present invention;

FIG. 35 is a flowchart for describing the operation step of a remind message registration portion according the fifth embodiment of the present invention;

FIG. 36 is a block diagram of a schedule reminder system according to a sixth embodiment of the present invention;

FIG. 37 is a block diagram of a schedule reminder system according to a seventh embodiment of the present invention;

FIG. 38 is a flowchart for describing the operation step of a remind message registration portion according to the seventh embodiment of the present invention;

FIG. 39 is a block diagram of a schedule reminder system according to an eighth embodiment of the present invention;

FIG. 40 is a flowchart for describing the operation step of a remind message registration portion according to the eighth embodiment of the present invention; and

FIG. 41 is a hardware block diagram according to ninth to 16th embodiments of the present invention.

### DETAILED DESCRIPTION OF THE PREFERRED EMBODIMENTS

A first embodiment of the present invention describes the most basic configuration and operation of the present invention. When a user specifies an event type of a schedule event and the date of the schedule event, a work item regarding the schedule event is sent to the user as a reminder message. A second embodiment of the present event does not directly specify an event type of a schedule event, but is freely be able to describe the contents of the schedule event. A third embodiment of the present invention is used to charge an advertisement in accordance with the sending frequency of a remind message when the advertisement is contained in the remind message. A fourth embodiment of the present invention is also used to select and add an appropriate advertisement even if no advertisement is originally contained in a remind message.

The schedule reminder system of the first or fourth embodiment reports a remind message to a user by electronic mail. The schedule reminder system of fifth or eighth embodiment operates in cooperation with a schedule management system of the calendar format, and is used to display a remind message on the calendar of the schedule management system. That is, the fifth embodiment, sixth embodiment, seventh embodiment, and eighth embodiment are modified so that the configuration and operation in the first embodiment, second embodiment, third embodiment, and fourth embodiment respectively enable linkage with the schedule management system.

The schedule management system of the present invention can be realized by additionally installing more software in a computer system that comprises predetermined hardware and the predetermined basic software installed in this hardware. In this case, the installation of the more software is performed by installing a recording medium in which software is recorded in the computer system in order to establish the computer system as a system that corresponds to the schedule management system of the first or eighth embodiment of the present invention. The schedule reminder system according to the embodiment of the present invention is further described in detail below.

First, terminology used in the following embodiments is defined. In this specification, a message reported to a user as a remind is called a remind message or merely called a message. Further, when n remind messages Mijs (1≦j≦n) are reported against an event type i at each different time Tij, the set of a combination of n Mijs and Tijs is called a checklist against the event type i. Further, a unique checklist ID is assigned to each event type, and specifying an event type has the same meaning with specifying a checklist ID.

### First Embodiment

In a first embodiment of the present invention, a user directly selects an event type (a checklist ID of a checklist to be used) of a schedule event, and a schedule reminder system sends a message contained in a specified checklist at a time specified in the checklist.

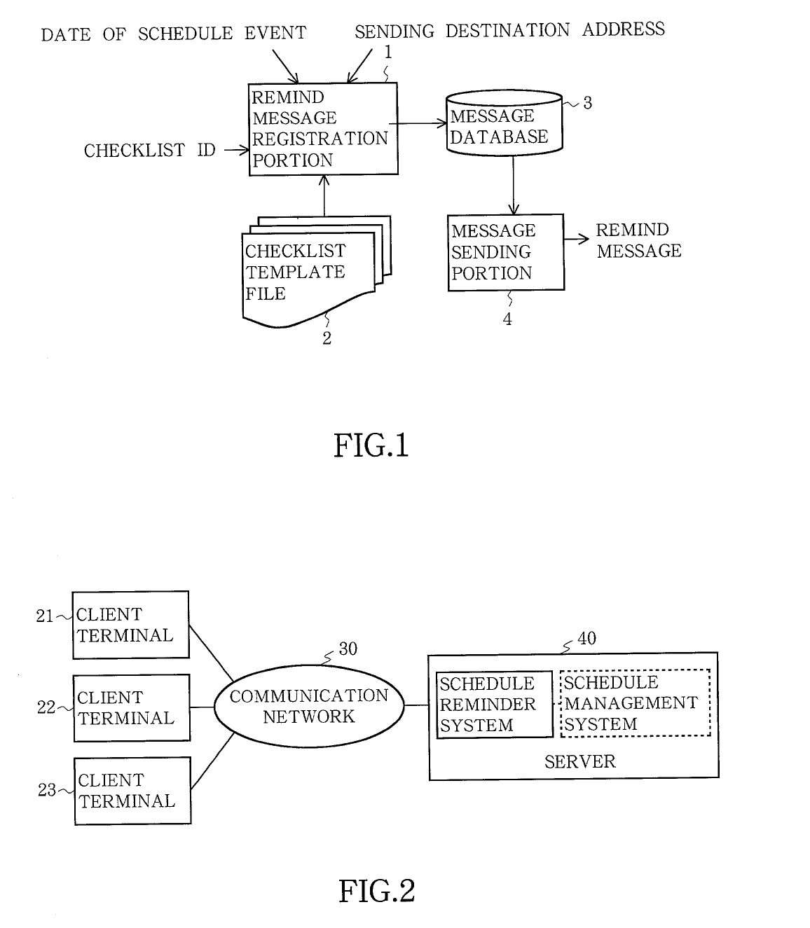

The system configuration, as shown in FIG. 1, consists of a remind message registration portion 1, a checklist template file 2, a message database 3, and a message sending portion 4.

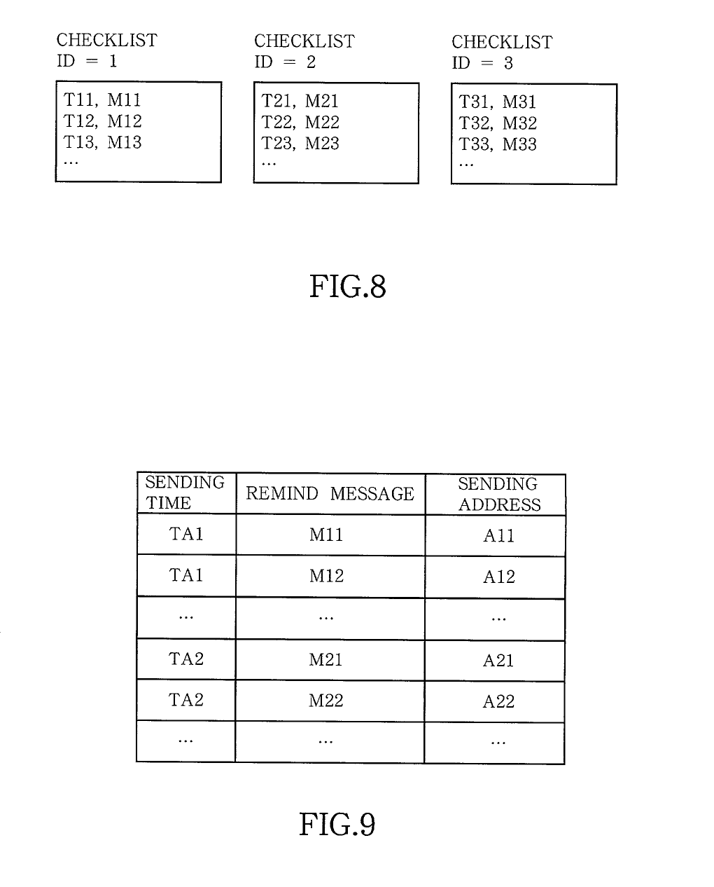

The checklist template file 2 is prepared as a different file for each event type at the side of a system, and a unique ID is previously assigned to each file. One combination or more of a remind message to be sent in an event type and the time at which the message is sent are described in each checklist template file 2. FIG. 8 shows an example of the checklist template file 2. A plurality of combinations of a time Tij and a remind message Mij are described in a checklist template file of which the ID is i. The format of a checklist template file is optional if the Tij and Mij can be discriminated. In this specification, as shown in FIG. 8, the Tij and Mij should be described in the CSV format. That is, when n different messages are sent to each user at a different time, they are described in n lines in a file and the J-th line will become the Tij, Mij. This indicates that the Mij is sent to the user at the time Tij.

The Tij description method is divided into an absolute value description and a relative value description. The absolute value description directly describes the time at which a message is to be sent, and, for example, a format of “twelve thirty on May 19, 2000” is used. The relative value description describes a relative time difference from a schedule event date TE, and, for example, a format of “ten days before the TE” or “three hours after the TE” is used. Further, the Mij is an optional character string.

The remind message registration portion 1 uses a checklist ID (event type), an event date at which an event occurs, and a sending destination address of a remind message as input to acquire the remind message and a message sending time referring to the contents of the checklist template file 2 that corresponds to an assigned checklist ID. If the message sending time is the relative value description, after the absolute date is calculated from the input event date, the remind message, message sending time, and sending destination address are registered in the message database 3.

The message database 3 holds the combination of the remind message, message sending time, and sending destination address as one record. FIG. 9 shows an example of the message database 3. The contents of a checklist that a plurality of users specified are collectively registered in the message database 3.

The message sending portion 4 sends a remind message of which the sending time elapsed to a sending destination address referring to the message database 3. In this configuration, since a user specifies a message sending destination address respectively, the same system can be used by a plurality of users.

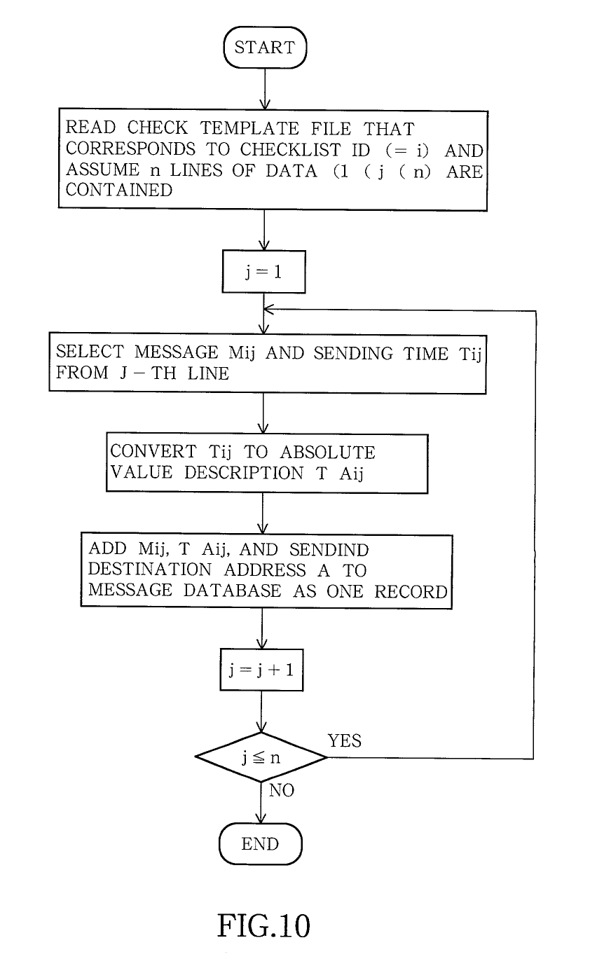

Next, the operation of a schedule reminder system according to the first embodiment of the present invention is described. The remind message registration portion 1 is activated when a schedule event date, a checklist ID, and a message sending destination address are specified by a user. The operation step in the remind message registration portion 1 is shown in the flowchart of FIG. 10. That is, first, a checklist template file that corresponds to a checklist ID (=1) is read. The following processing is further performed against each line, assuming that n lines of data are contained in the file. First, a message Mij and a sending time Tij are sampled from the J-th line. Then the sending time Tij is converted to an absolute value description T Aij. More specifically, if the Tij is a relative value description, the Tij is converted from the TE and the absolute value description T Aij is calculated. Finally, the Mij, Tij, and a sending destination address A are added to the message database 3 as one record.

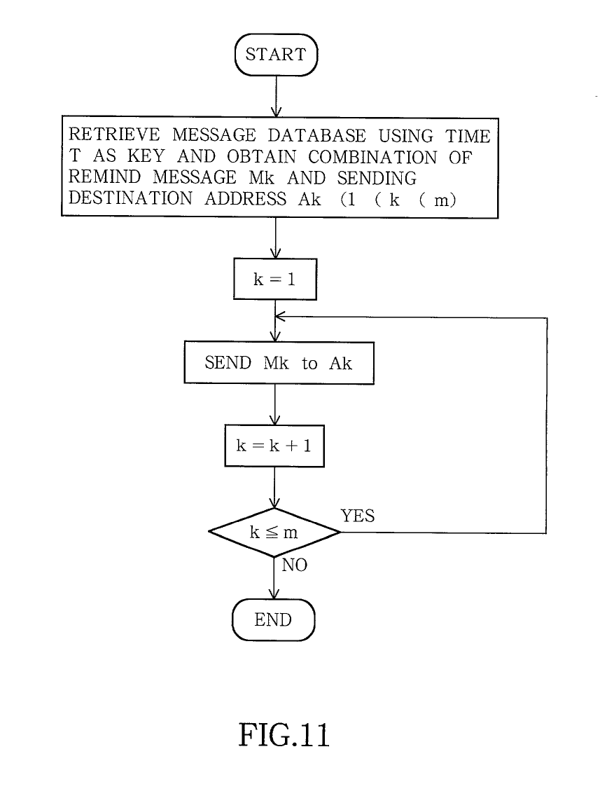

Further, the message sending portion 4 operates independently of the remind message registration portion 1, accesses the message database 3 every fixed time, and sends a message. The operation step of the message sending portion 4 is shown in the flowchart of FIG. 11. That is, at a time T, the message database 3 is retrieved using the time T as a key and all records of which the sending time is the T are acquired. The remind message and the sending destination address contained in the k-th record acquired here are Mk and Ak (1≦k≦m) respectively. In all m records, the remind message Mk is sent to the sending destination address Ak respectively.

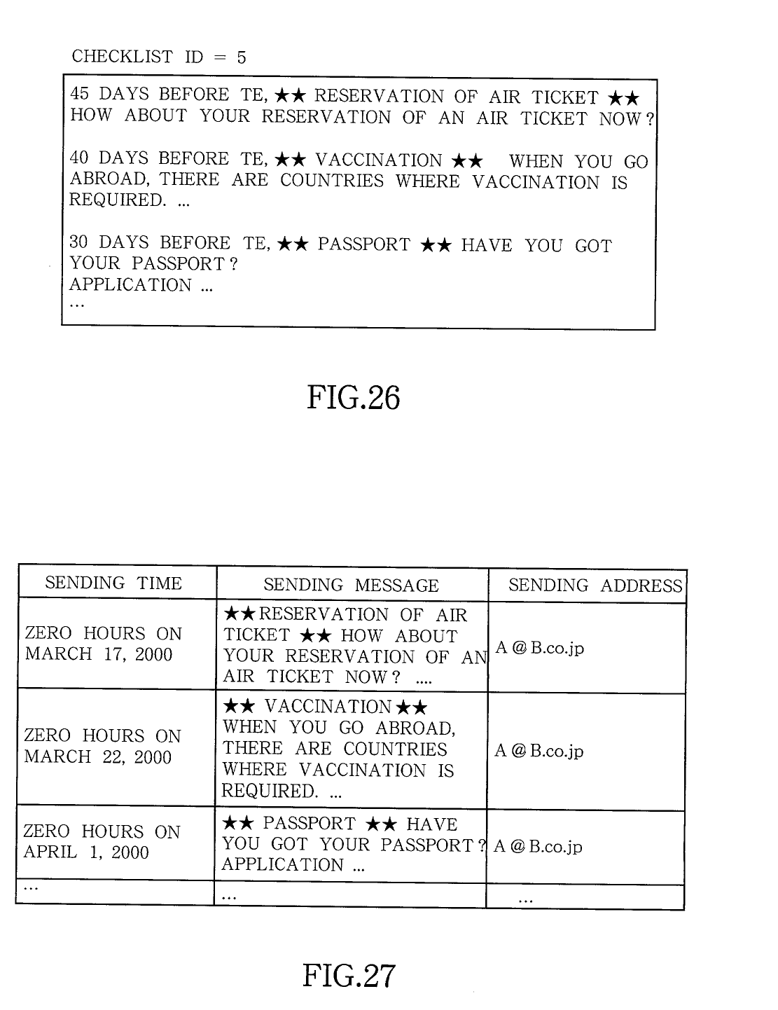

The operation is described here using specific data. For example, as shown in 5, a user selects a checklist for preparing an overseas travel (the checklist ID is “5”) for the event type of the “overseas travel”, and specifies “zero hours on May 1, 2000” for the schedule event time TE. Moreover, the user specifies an electronic mail address “A@B.co.jp” as the message sending destination address A. Further, the checklist template file of which the checklist ID is “5” is assumed to have such description as shown in FIG. 26.

In this case, the remind message registration portion 1 selects a sending time and a remind message from the file of FIG. 26 by one line, converts the sending time to an absolute value description, and then registers the result in the message database 3 together with the sending destination address “A@B co.jp” as shown in FIG. 27. For example, when the first line of the file of FIG. 26 is processed, since the sending time is “45 days before TE”, “zero hours on Mar. 17, 2000” that is before 45 days from the TE “zero hours on May 1, 2000” is registered in the message database 3.

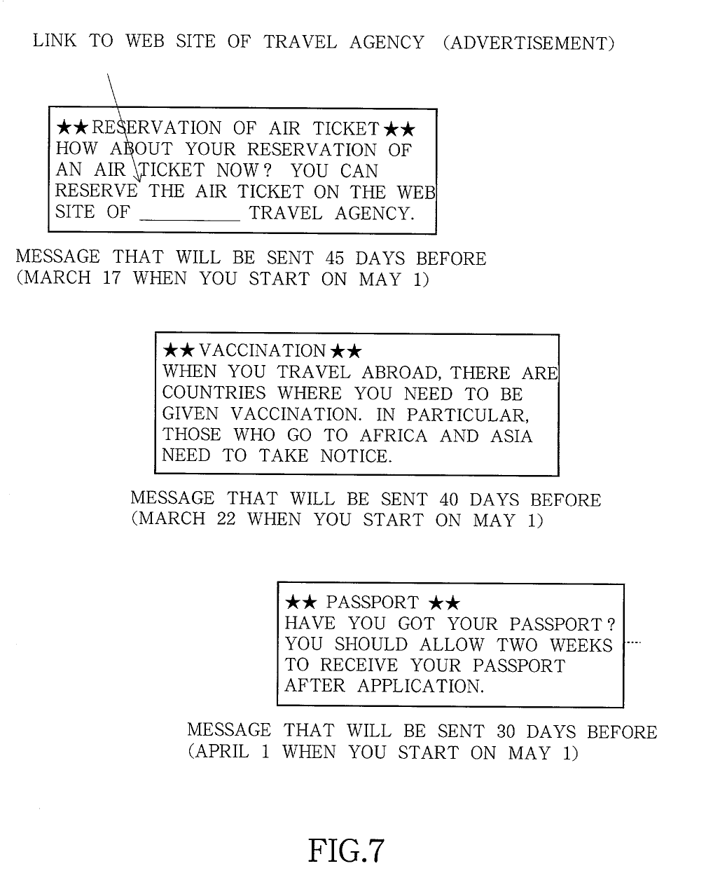

The message sending portion 4, for example, accesses the message database 3 every minute. When the accessed time is “zero hours on Mar. 17, 2000”, the first-line message of the message database 3 is sent to the sending destination address “A@B.co.jp”. As a result, as shown in FIG. 7, the message will be sent to a user.

### Second Embodiment

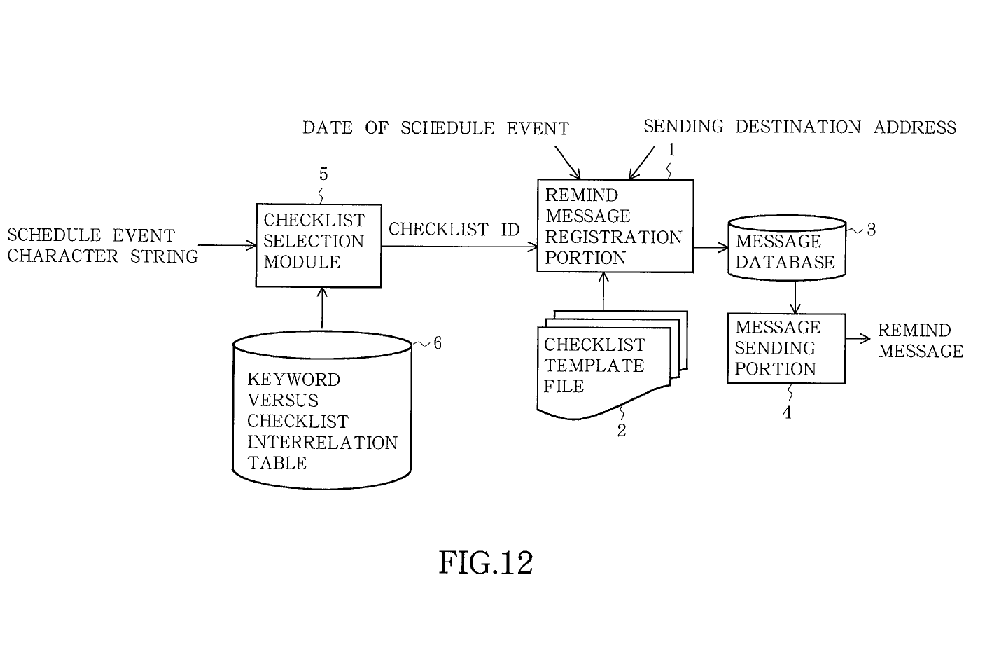

In a second embodiment of the present invention, as shown in FIG. 6, a user automatically selects an event type (checklist ID) for a character string of a schedule event the user freely entered instead of specifying the type of schedule event. The system configuration is shown in FIG. 12. The second embodiment differs from the first embodiment in that a checklist selection module 5 and a keyword versus checklist interrelation table 6 are added. The second embodiment has the same configuration and operation as the first embodiment except that a checklist is automatically selected using the checklist selection module 5 and the keyword versus checklist interrelation table 6.

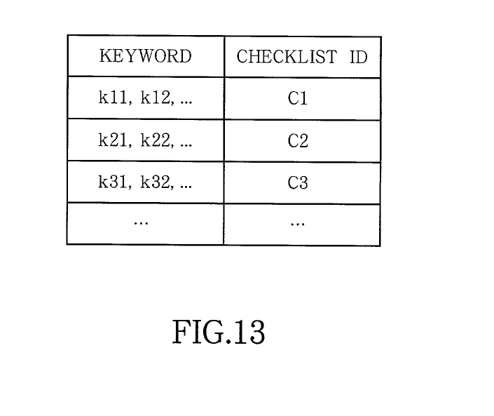

The keyword versus checklist interrelation table 6 holds a checklist ID regarding a specific keyword. FIG. 13 shows an example of a keyword versus checklist interrelation table.

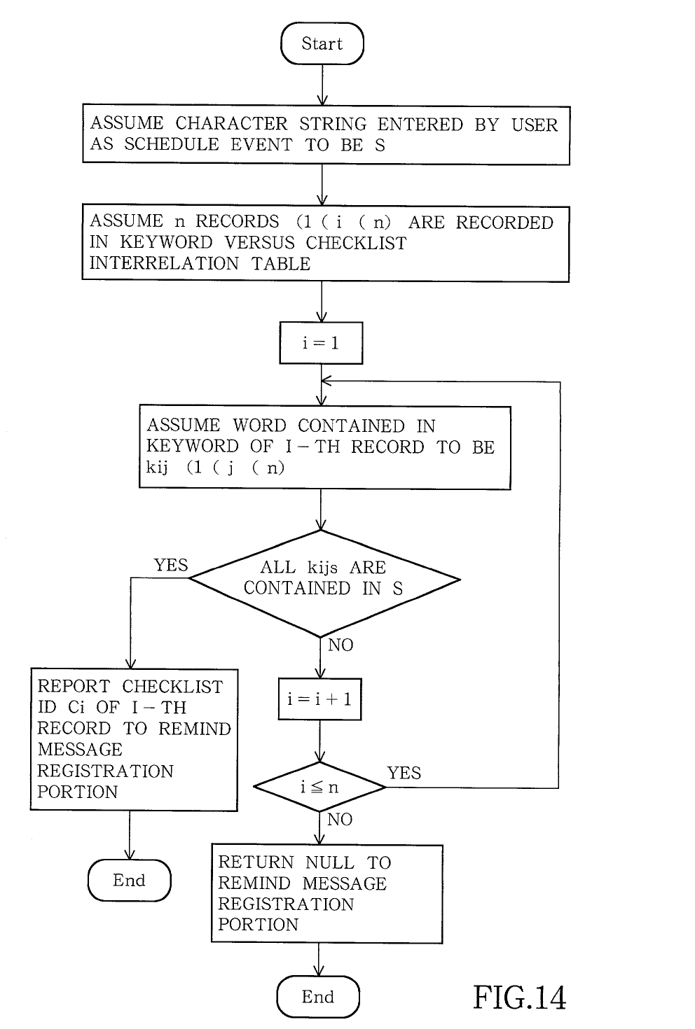

The checklist selection module 5 checks that a specific keyword is contained in a character string S of a schedule event entered by a user. When it is contained, a checklist ID that corresponds to the keyword is selected. FIG. 14 is a flowchart for describing the operation step of the checklist selection module 5. It is assumed that the keyword versus checklist interrelation table 6 registers n records. The checklist selection module 5 performs the following processing for each record of the keyword versus checklist interrelation table 6. The word contained in the keyword field of the I-th record is Kij (1≦j≦m). When all kijs are contained in the character string S of the schedule event entered by the user, a checklist ID “Ci” of the I-th record is reported to the remind message registration portion 1 and processing terminates. Otherwise, the processing is repeated until a record that satisfies this decision condition is satisfied. If the record cannot be found in all n records, NULL (a null character) is returned to the remind message registration portion 1.

The entire system operation of the second embodiment is as follows. First, the checklist selection module 5 receives a character string S that indicates the contents of a schedule event from a user and performs the checklist selection processing as described previously. The remind message registration portion 1 receives a checklist ID from the checklist selection module 5, and an event date TE and a sending destination address A as the input from the user and performs the remind message registration processing. Specifically, if no checklist is selected from the checklist selection module 5 and the output is NULL, the entire processing terminates. If the output is not NULL, the same processing as the remind message registration portion 1 of the first embodiment is performed. The message sending portion 4 operates independently in the same manner as the first embodiment and sends a message to a user every fixed time.

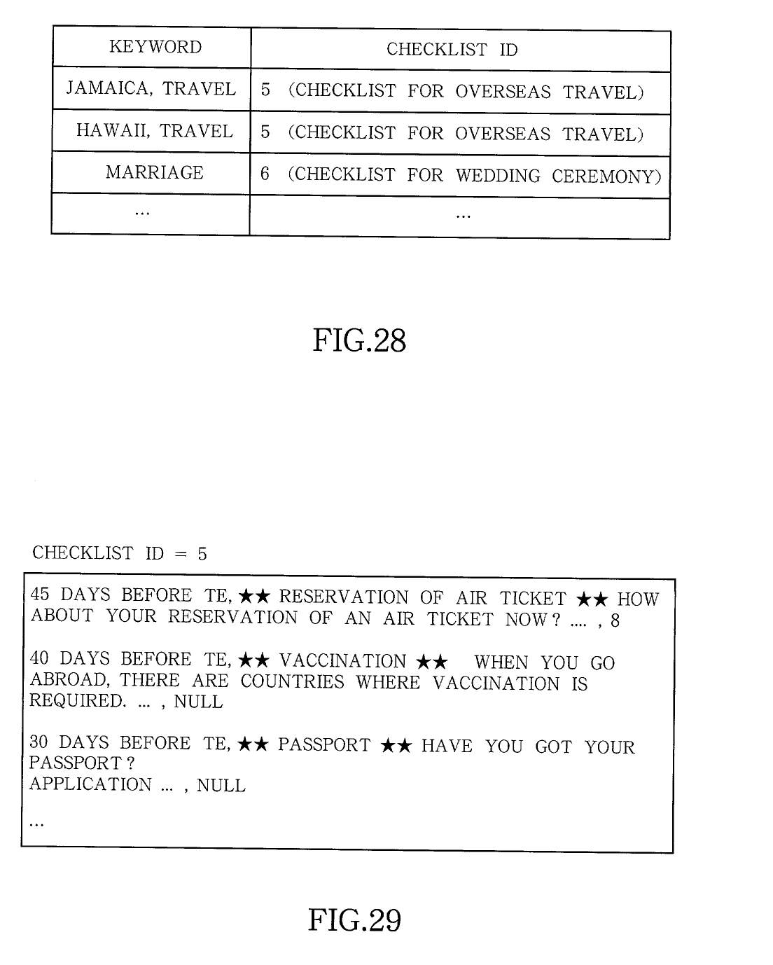

The operation of the checklist selection module 5 is described here using specific data. It is assumed that such data as shown in FIG. 28 is registered in the keyword versus checklist interrelation table 6. Further, it is assumed that a user has entered a “travel to Hawaii” as the character string S of a schedule event, as shown in FIG. 6.

The checklist selection module 5 first acquires keywords “Jamaica” and “travel” registered in the first line of the keyword versus checklist interrelation table 6 and checks for S that these two keywords are contained together. However, they are not contained, the second-line keyword is acquired. Since the second-line keywords “Hawaii” and “travel” are contained in S together, “5” that is the second-line checklist ID is output as a result and processing terminates.

### Third Embodiment

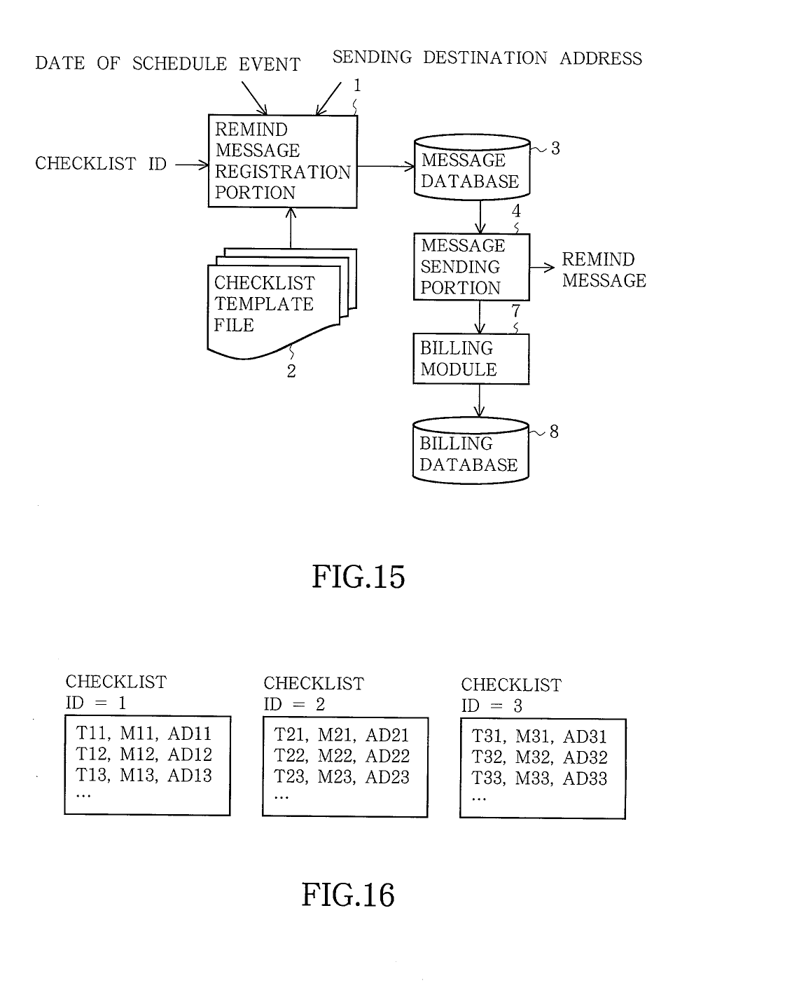

The reminder system according to a third embodiment of the present invention indicates that an advertisement is contained in a remind message. The system configuration is shown in FIG. 15. The system configuation of the third embodiment differs from that of the first embodiment in that a billing module 7 and a billing database 8 are added.

However, in order to charge the advertisement contained in the message that was sent, the operation and contents of the remind message registration portion 1, the checklist template file 2, the message database 3, and the message sending portion 4 slightly differ.

FIG. 16 shows the format of the checklist template file 2. The difference for the checklist template file 2 shown in FIG. 8 in the first embodiment is that an advertisement ID “A Dij” is added to each line of the checklist template file 2. The A Dij indicates that a sentence that corresponds to the advertisement ID “A Dij” is inserted in Mij. When no advertisement is contained in the Mij, the A Dij is set to NULL. The format of each line of a file is a “sending time, remind message, advertisement ID”.

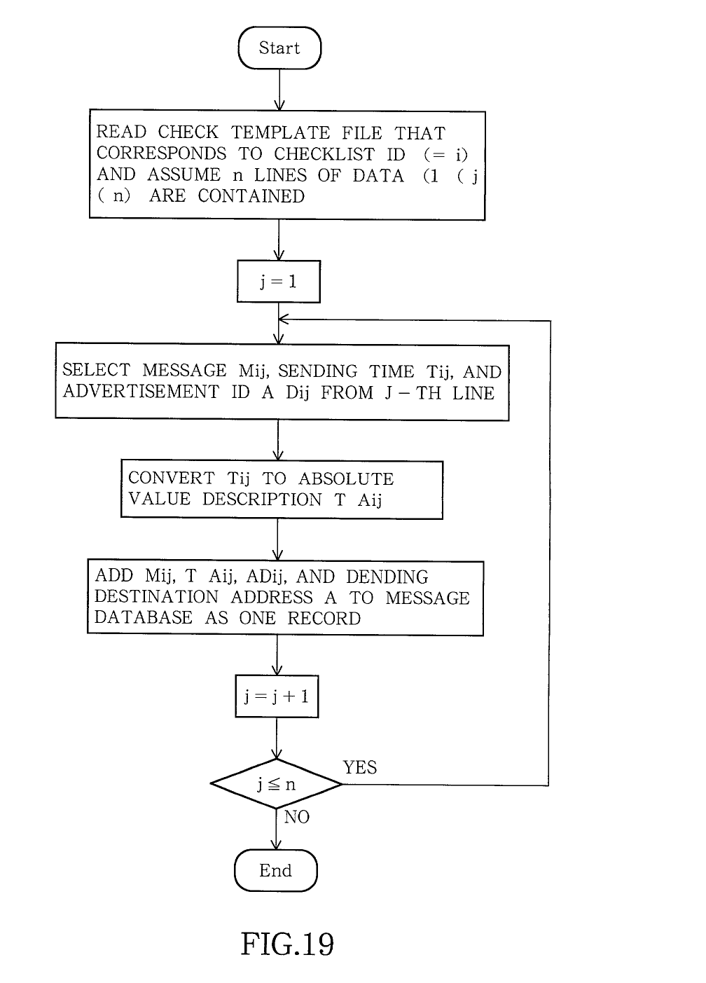

The difference for the first embodiment of the remind message registration portion, as shown in the flowchart of the third embodiment of FIG. 19, is that an advertisement ID is also acquired together from the checklist template file 2 of the format of FIG. 16 and the advertisement ID is also registered together in the message database 3.

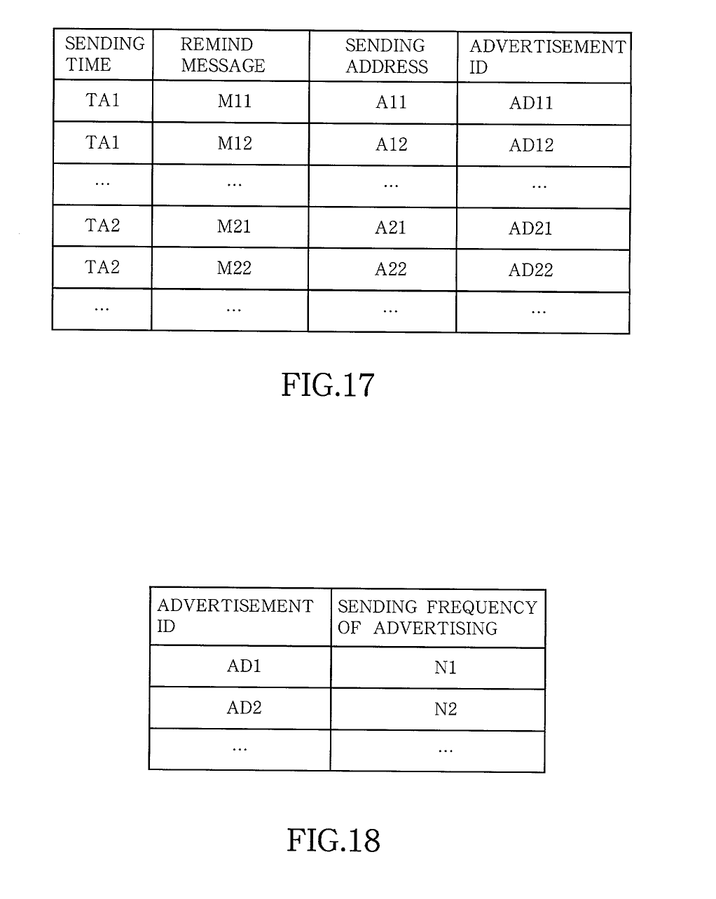

The difference for the first embodiment of the message database 3, as shown in FIG. 17, is that an advertisement ID is also held together in each record.

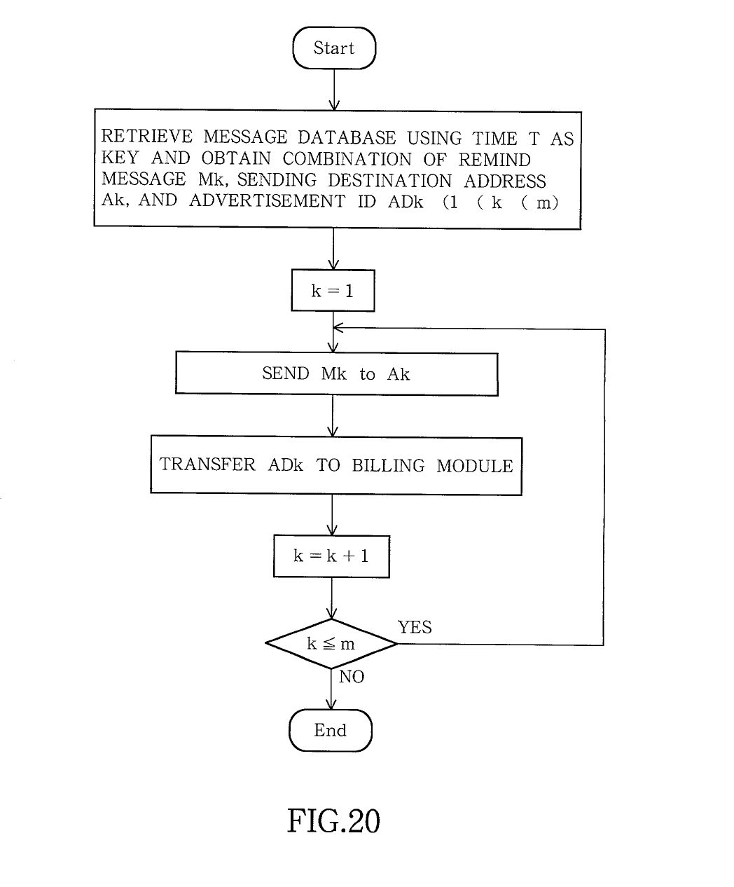

The difference for the first embodiment of the message sending portion 4 is that an advertisement ID “ADk” of the advertisement contained in a remind message is transferred to the billing module 7. FIG. 20 is a flowchart for describing the operation step of the message sending portion 4. First, a message database is retrieved using a time T as a key. Hereupon, it is assumed that m records have been retrieved. The following processing is performed against each of m records (1≦k≦m). A combination of a remind message Mk, a sending destination address Ak, and an advertisement ID “ADk” contained in the k-th record is acquired and the remind message Mk is sent to the sending destination address Ak. At that time, the ADk is transferred to the billing module 7.

The billing database 8 holds an advertisement ID and the frequency at which the advertisement that corresponds to the advertisement ID was sent to a user. FIG. 18 shows an example of the billing database 8. Advertising rates are charged in accordance with the sending frequency of advertising that is recorded in this billing database 8.

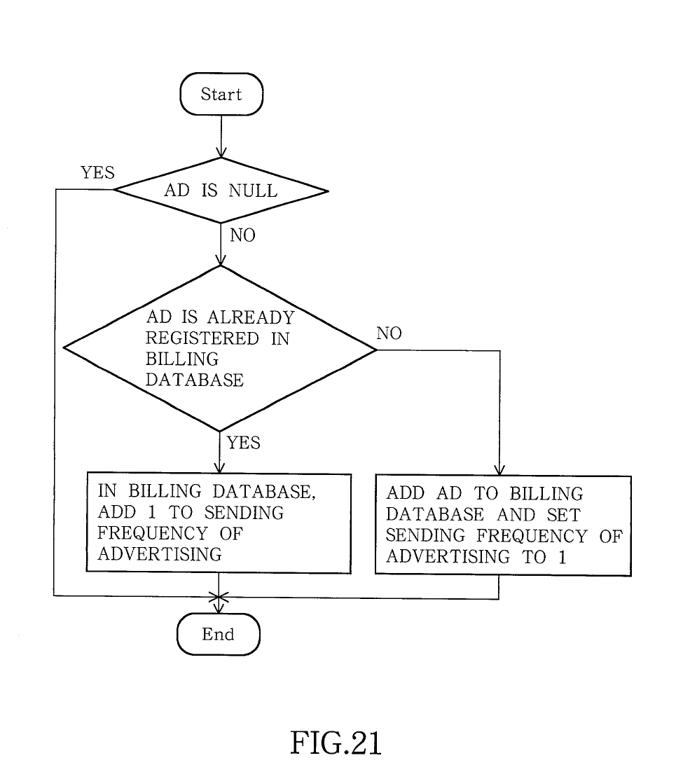

The billing module 7 receives an advertisement ID from the message sending portion 4 and counts the sending frequency of advertising every advertisement ID. FIG. 21 is a flowchart for describing the operation step of the billing module 7. That is, the billing module 7 uses an advertisement ID “AD” as input. When the AD is NULL, processing terminates without performing anything. When the AD is not NULL and the AD is registered in a billing database, the sending frequency of advertising is counted up (incremented) by 1. When the AD is NULL and the AD is not registered in the billing database 8, a record is added to the billing database 8 by setting the frequency of advertising of the AD to “1”.

Next, the entire operation in the third embodiment of the present invention is described. In the same manner as the first embodiment, when a user specifies a date of a schedule event, a message sending destination address, and a checklist ID, the remind message registration portion 1 performs the message registration processing shown in the flowchart of FIG. 19 referring to a checklist template file. Further, in the same manner of the first embodiment, the message sending portion 4 also operates independently of the remind message registration portion 1 and accesses the message database 3 every fixed time. As shown in the flowchart of FIG. 20, the message sending portion 4 sends a message and transfers an advertisement ID of the advertisement contained in the sent message to the billing module 7. Further, the billing module 7 is activated when the ID is transferred from the message sending portion 4 and performs the billing processing shown in the flowchart of FIG. 21.

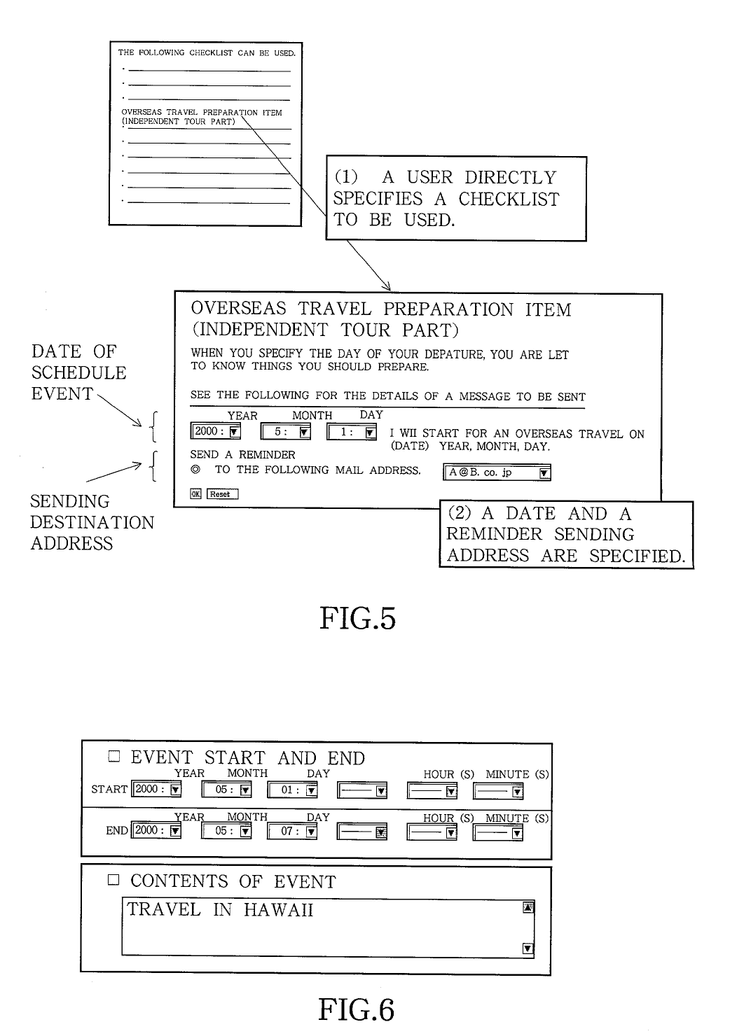

The operation is described here using specific data. For example, as shown in FIG. 5, it is assumed that a user selects a checklist (checklist ID is “5”) for preparing an overseas travel and specifies “zero hours on May 1, 2000” for a schedule event time TE. Moreover, it is assumed that the user specifies an electronic mail address “A@B.co.jp” as the message sending destination address A. Further, it is assumed that the checklist template file 2 of which the checklist ID is “5” has such description as shown in FIG. 29.

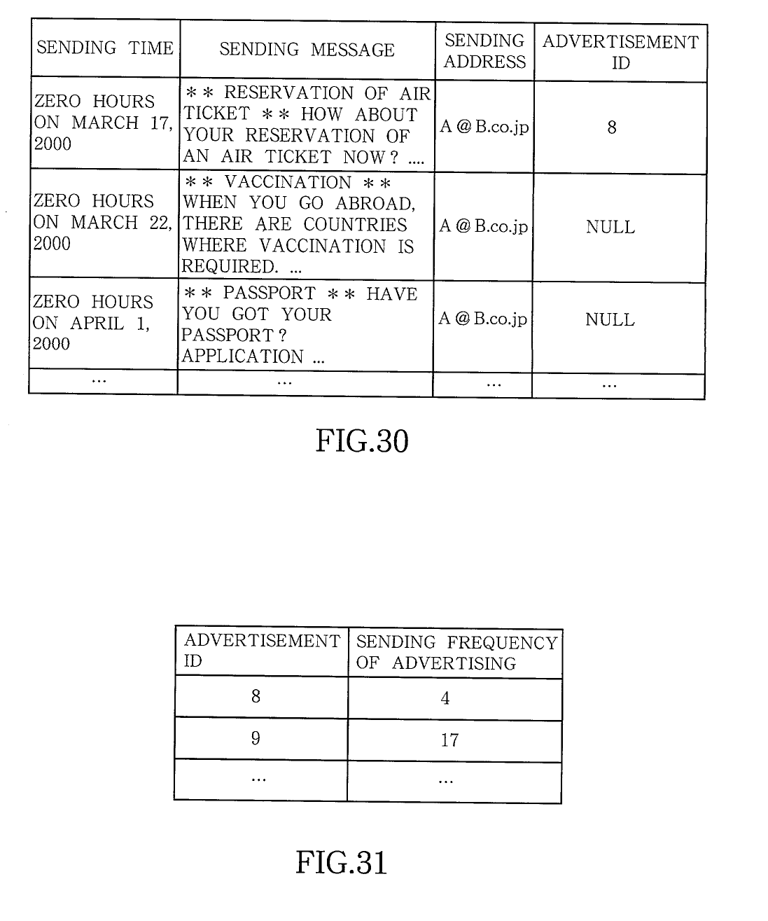

In this case, the remind message registration portion 1 samples a sending time, a remind message, and an advertisement ID by one line from the file of FIG. 29. After the sending time is converted to an absolute value description, it is registered in the message database 3 together with a sending destination address “A@B.co.jp” as shown in FIG. 30.

The message sending portion 4, for example, accesses the message database 3 every minute. When the accessed time is zero hours on Mar. 17, 2000”, the first-line message of the message database 3 is sent to the sending destination address “A@B.co.jp”.

As a result, a message will be sent to a user as shown in FIG. 7. Besides, the message sending portion 4 transfers an advertisement ID that corresponds to the sent message to the billing module 7. That is, the message sending portion 4 transfers “8” as the advertisement ID when the first-line message is sent, and NULL as the advertisement when the third-line and second-line messages are sent, to the billing module 7.

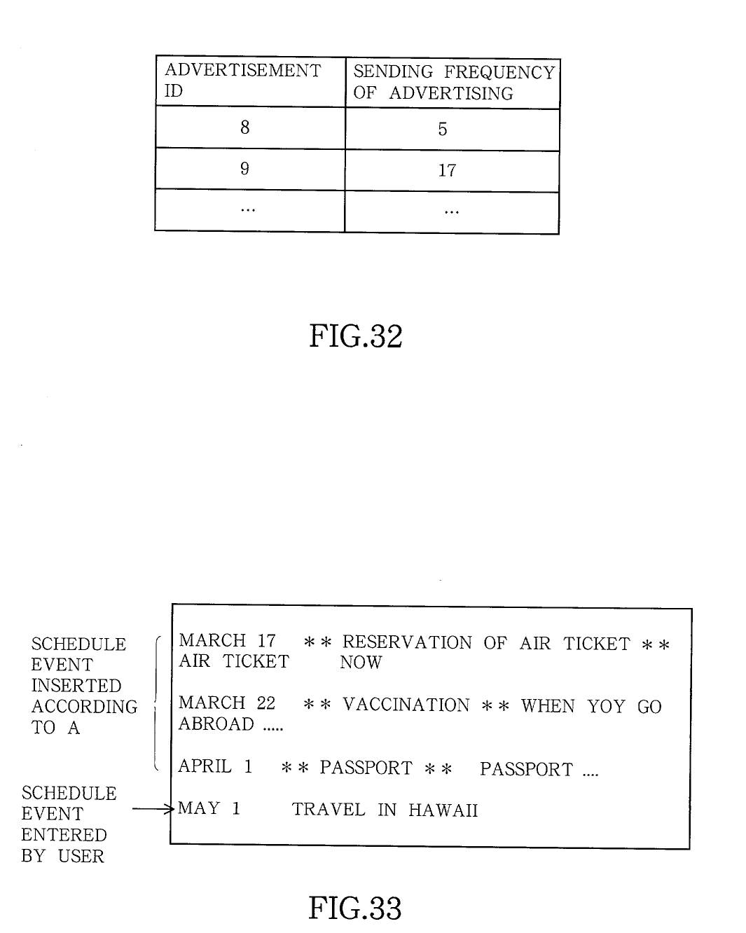

The billing module 7 receives the advertisement ID “8”, and the sending frequency of advertising of the advertisement ID is counted up (incremented) by 1. For example, when the billing database 8 is in such a state shown in FIG. 31, it is updated as shown in FIG. 32. When NULL is received, processing terminates without performing anything.

### Fourth Embodiment

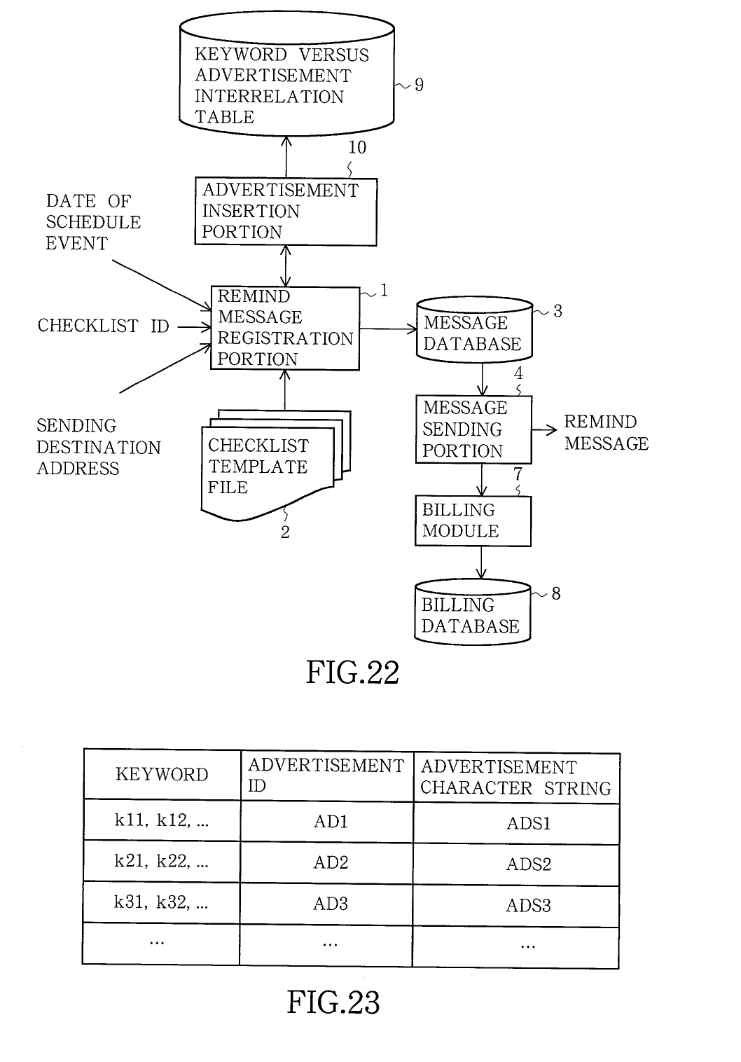

A fourth embodiment of the present invention is used to automatically insert an advertisement in a remind message. The system configuration is shown in FIG. 22, and the difference for the system configuration with the third embodiment is that an advertisement insertion portion 10 and a keyword versus advertisement interrelation table 9 are added. In the fourth embodiment, a keyword contained in a remind message is checked in the advertisement insertion portion 10 and an advertisement that corresponds to the keyword is acquired from the keyword versus advertisement interrelation table 9, and then is added to the original remind message.

However, to automatically insert an advertisement, the operation and contents of the remind message registration portion 1 slightly differ from those of the third embodiment. The checklist template file 2 has the same contents as the first embodiment. The message database 3, the message sending portion 4, the billing embodiment, and the billing database 8 are identical with those of the third embodiment.

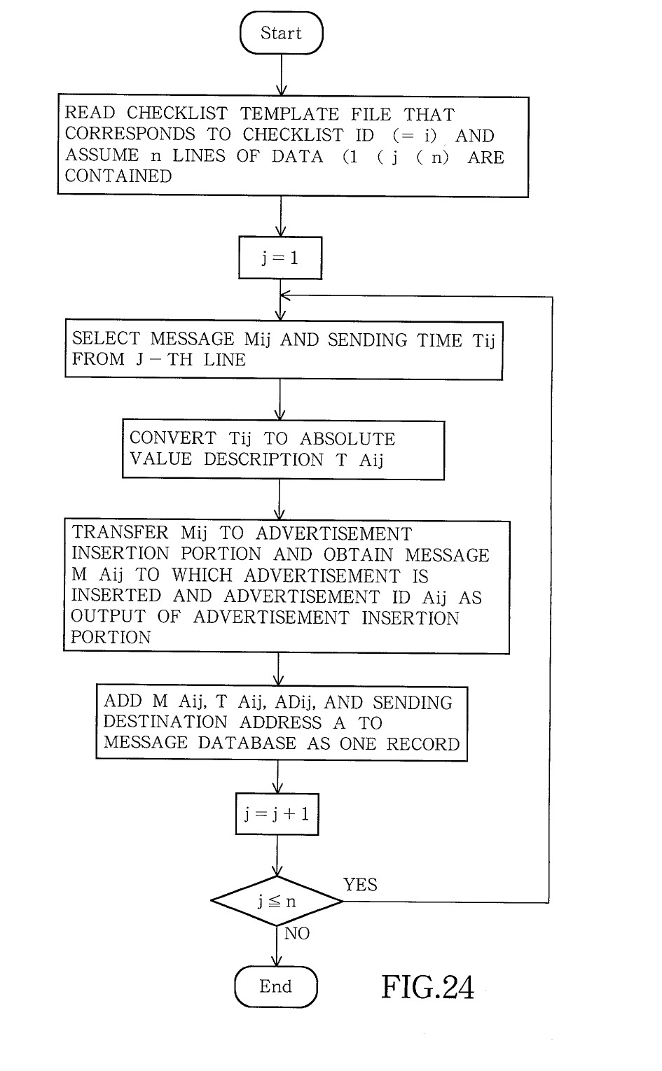

The difference for the third embodiment of the remind message registration portion 1 is to transfer a remind message Mij to the advertisement insertion portion 10 in order to insert an advertisement to the Mij and acquire an advertisement ID that corresponds to the inserted advertisement. FIG. 24 is a flowchart for describing the operation step of the remind message registration portion 10 of the fourth embodiment. First, a checklist template file that corresponds to a checklist ID (=I) is read. N lines of data (1≦j≦n) are assumed to be contained here. Next, the following processing is performed for all the n lines obtained here. A message Mij and a sending time Tij are selected from the j-th line and the Tij is converted to a description of the absolute value T Aij. The Mij is transferred to the advertisement insertion portion 10, and a message M Aij to which an advertisement is inserted and an advertisement ID “A Dij” are obtained as a processing result in the advertisement insertion portion 10. The M Aij, T Aij, A Dij, and sending destination address A are added to the message database 3 as one record.

The keyword versus advertisement interrelation table 9 holds an advertisement ID regarding a specific keyword and the character string of the advertising copy. FIG. 23 shows an example of the keyword versus advertisement interrelation table 9. As a specific example, a keyword of a “hotel”, an advertisement ID for reserving a hotel, and an advertising copy “You can reserve a hotel at the Web site of ______ Travel Agency” will be associated.

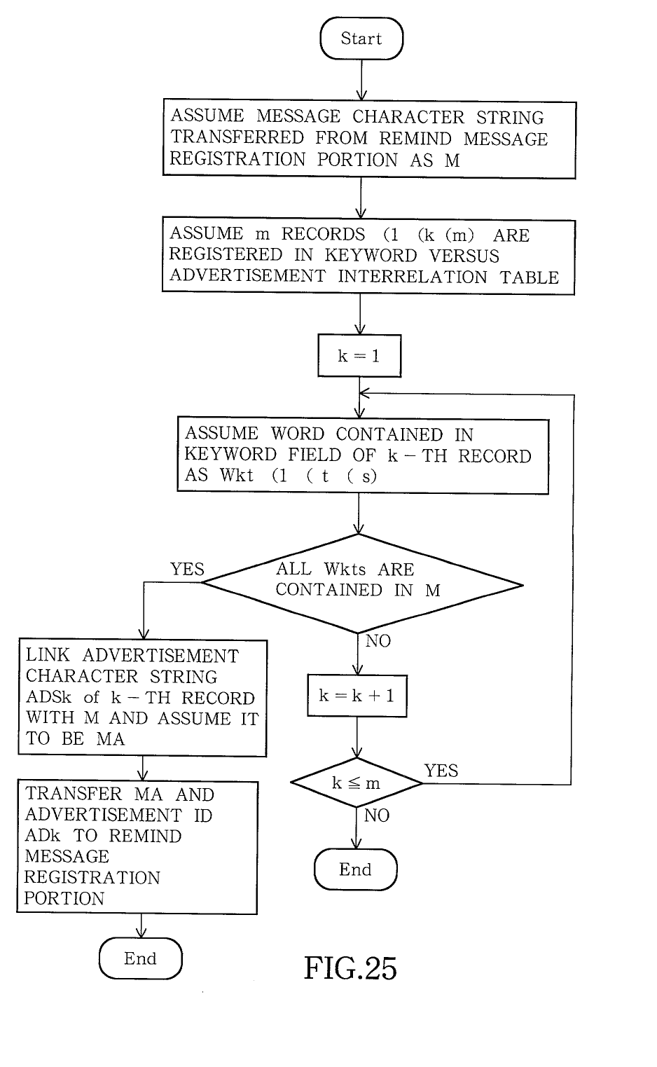

The advertisement insertion portion 10 uses a remind message M as input to select an advertisement regarding the contents of M referring to the keyword versus advertisement interrelation table 9. FIG. 25 is a flowchart for describing the operation step of the advertisement insertion portion 10 of the fourth embodiment. First, the remind message character string M is received from the remind message registration portion 1. Then the following processing is performed for all the m records (1≦k≦m) registered in the keyword versus advertisement interrelation table 9. In the k-th record, when all words Wkts (1≦t≦s) contained in the keyword field are contained in the M, an advertising copy ADSk of the k-th record is coupled with the M and specified as an MA. Subsequently, an advertisement ID “ADk” that corresponds to the MA is transferred to the remind message registration portion 1 and processing terminates at that point. When all Wkts are not contained in the M, the same judgment is sequentially performed concerning other records.

### Fifth Embodiment

A fifth embodiment of the present invention is used to display a remind message on the calendar of a schedule management system by operating in cooperation with a schedule management system 11 of the calendar format instead of sending a message contained in a checklist by electronic mail. For example, as shown in FIG. 33, the remind message is displayed matching a schedule event which a user has entered in the calendar in accordance with the type of the schedule event. The schedule management system 11 has general functions, such as the contents and date of the schedule event of the user and a module that displays the user schedule in the calendar format as a schedule management system.

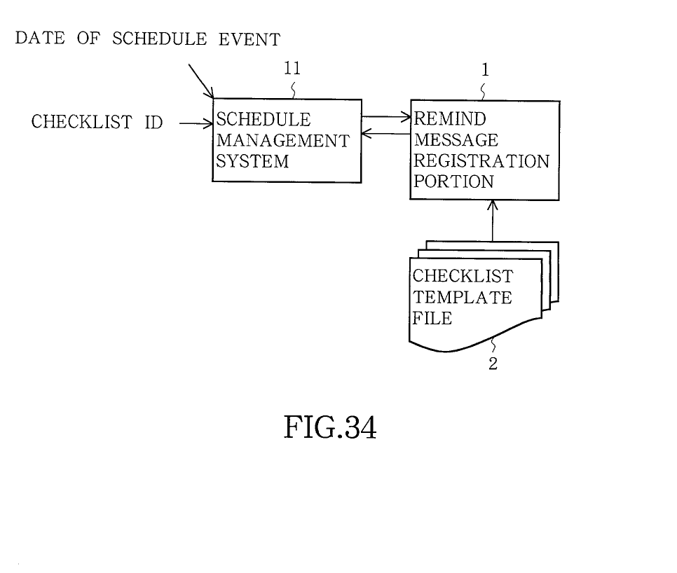

The system configuration is shown in FIG. 34. A type of a schedule event (checklist ID) is transferred to a schedule reminder system via a schedule management system and the schedule reminder system returns a remind message regarding the schedule event to the schedule management system 11. The remind message is displayed using the function of the schedule management system.

The contents of the checklist template file 2 according to the fifth embodiment are identical with those of the first embodiment.

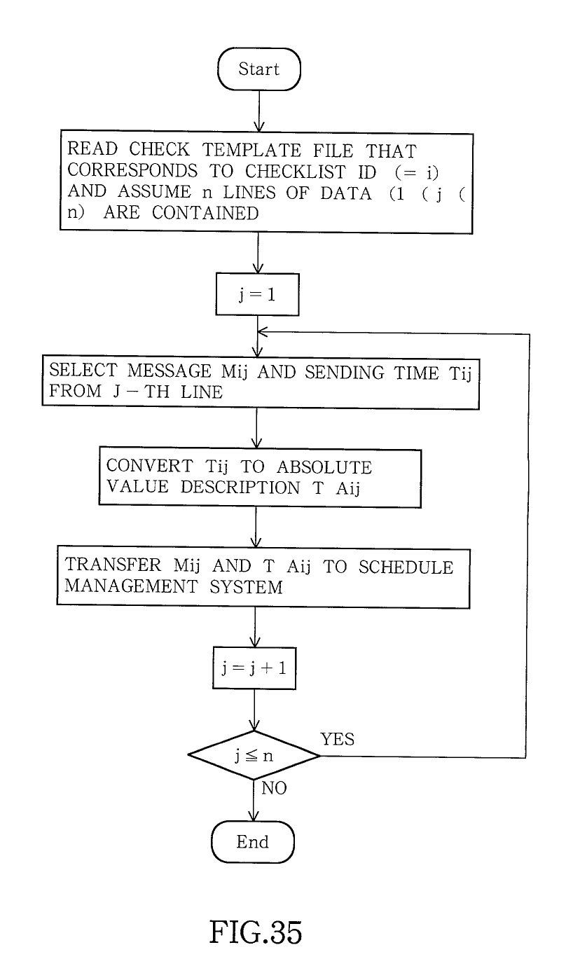

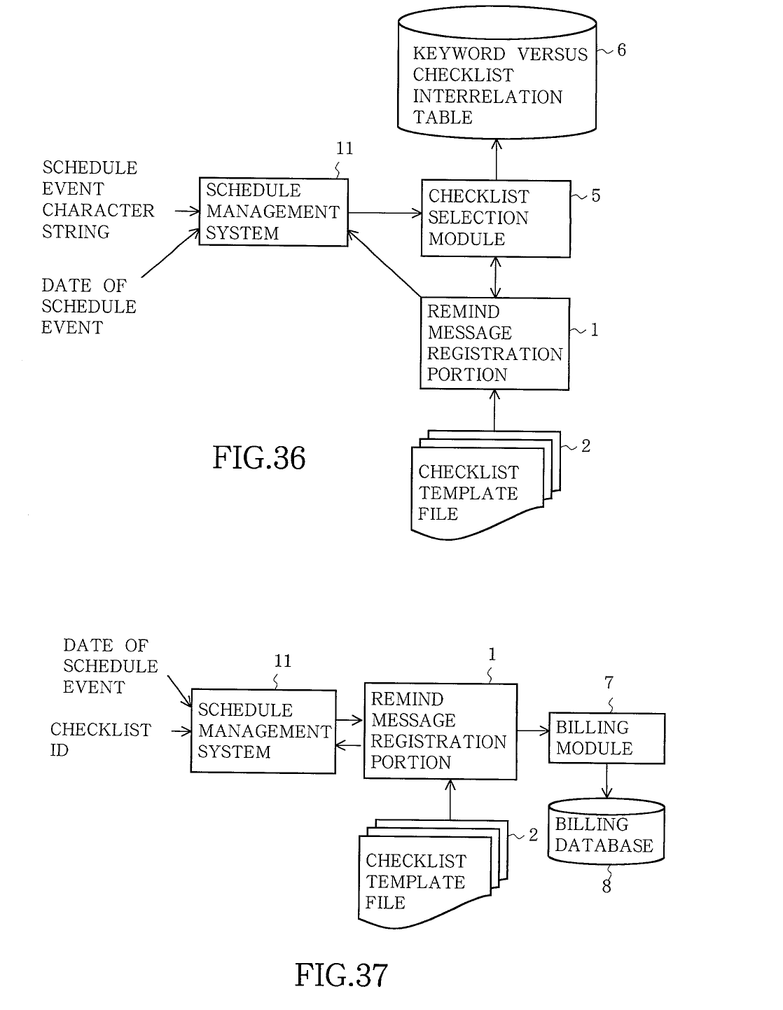

The remind message registration portion 1 of the fifth embodiment 5 uses the date of a schedule event and a checklist ID as input and transfers a remind message and the time to a schedule management system referring to the checklist template file 2 that corresponds to the checklist ID. FIG. 35 is a flowchart for describing the operation step of the remind message registration portion 1. First, a checklist template file that corresponds to a checklist ID (=i) is read. The following processing is performed for all n lines of data (1≦j≦n) contained the checklist template file. In the j-th line, a message Mij and a sending time Tij are selected and the Tij is converted to an absolute value description T Aij. The Mij and the T Aij are transferred to the schedule management system 11.

### Sixth Embodiment

A sixth embodiment of the present invention has the system configuration in which the configuration in which a checklist is automatically selected from a character string of a schedule event freely entered by a user to the system configuration of the fifth embodiment. The keyword versus checklist interrelation table 6 and the checklist selection module 5 are identical with those of the second embodiment. Others are identical with those of the fifth embodiment.

### Seventh Embodiment

A seventh embodiment of the present invention has the system configuration in which the configuration in which an advertisement is charged is added to the system configuration of the fifth embodiment. The checklist template file 2, the billing module 7, and the billing database 8 are identical with those of the third embodiment.

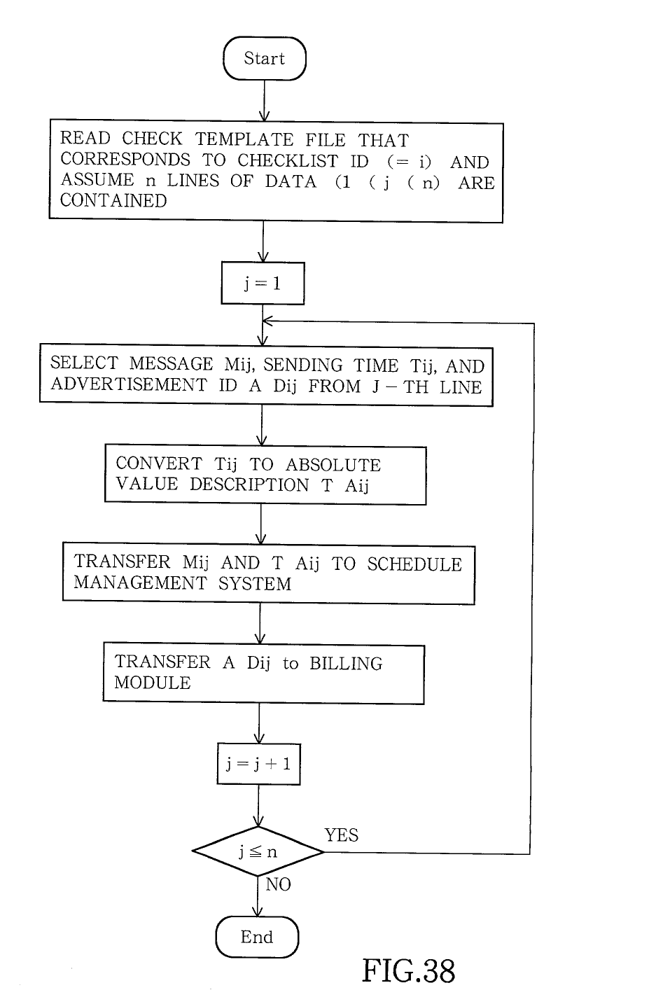

The difference between the reminder message registration portion 1 of the seventh embodiment and the reminder message registration portion 1 of the fifth embodiment is that an advertisement described in the checklist template file 2 is transferred to the billing module 7. FIG. 38 is a flowchart for describing the operation step of the remind message registration portion 1. When a remind message and the time is transferred to the schedule management system 11, the corresponding advertisement is transferred to the billing module 7 at the same time.

### Eighth Embodiment

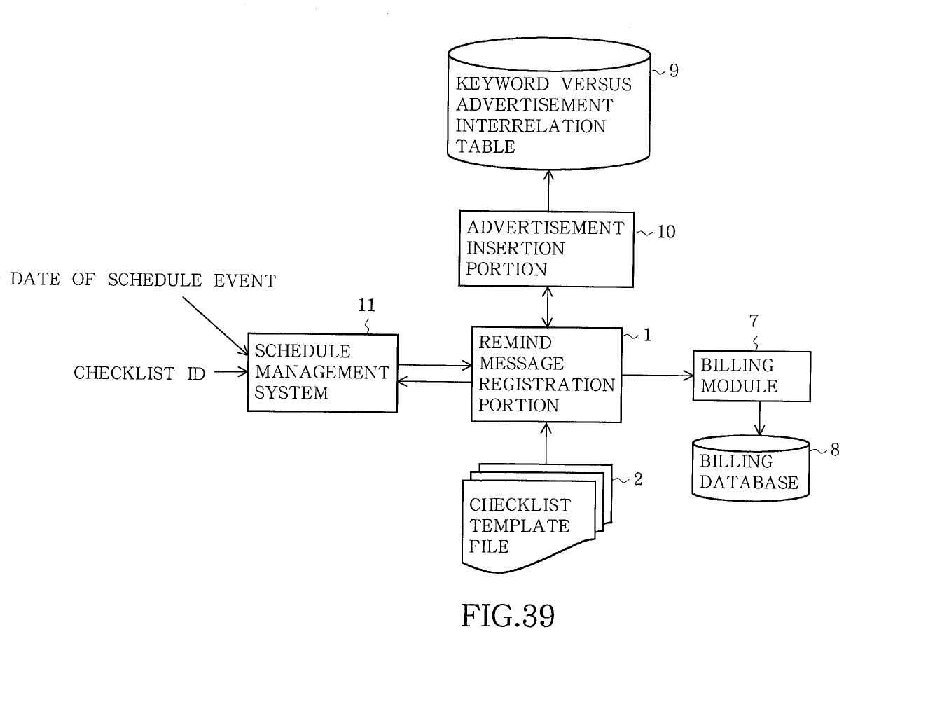

An eighth embodiment of the present invention, as shown in FIG. 39, in the system configuration of the seventh embodiment, can automatically add an advertisement to a remind message. The difference of the system configuration for the seventh embodiment is that the advertisement insertion portion 10 and the keyword versus advertisement interrelation table 9 are added. The checklist template file 2, the billing module 7, and the billing database 8 are identical with those of the seventh embodiment, and, the advertisement insertion portion 10 and the keyword versus advertisement interrelation table 9 are identical with those of the fourth embodiment.

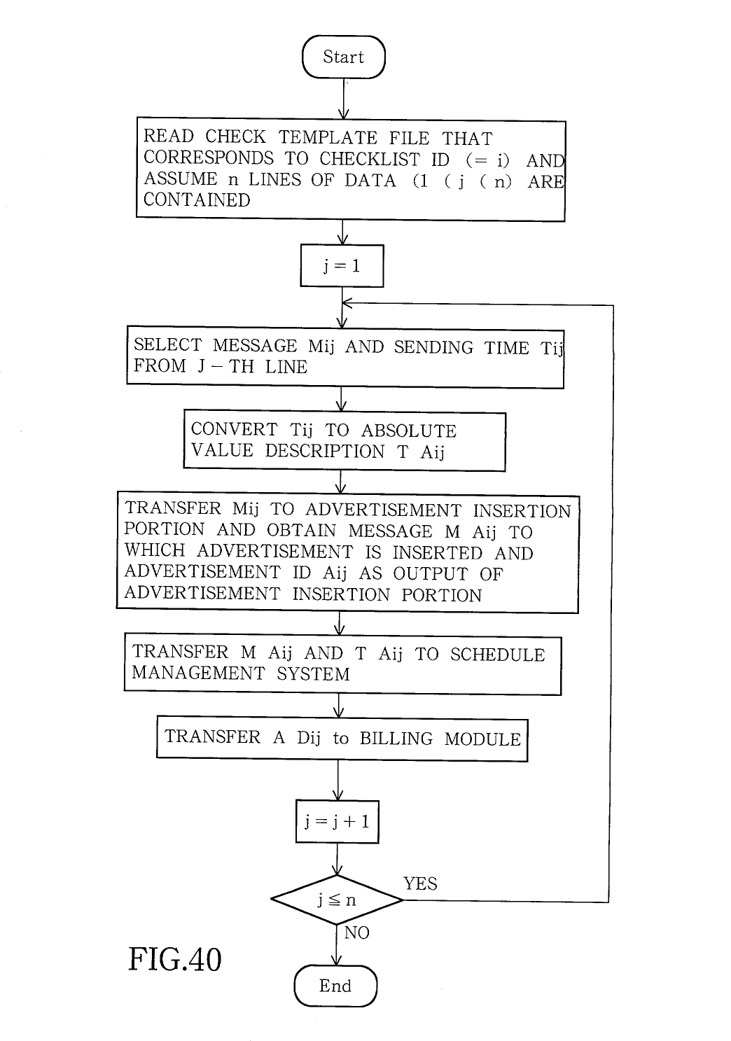

However, the operation of the remind message registration portion 1 differs. FIG. 40 is a flowchart for describing the operation step of the remind message registration portion 1. As shown in FIG. 40, first, a remind message contained in a checklist template file is transferred to the advertisement ID 10 and a remind message to which an advertisement is inserted and the advertisement ID are acquired. Then billing processing is performed by transferring the remind message to which the advertisement to the schedule management system 11, and transferring the acquired advertisement ID to the billing module 7.

Besides, a checklist can automatically be selected by having the configuration in which a checklist selection module and a keyword versus checklist interrelation table are added to the system configuration of the third or fourth embodiment, and by having the configuration in which a checklist selection module and a keyword versus checklist interrelation table are added to the system configuration of the seventh or eighth embodiment.

Further, a description was given from the first embodiment to the fourth embodiment assuming a remind message is sent to a user using electronic mail. As notification means to the user, if character information, such as short messages by a facsimile system or cellular phone, can be sent to the user at a specific time, the means is not limited.

Further, a description was given from the fifth embodiment to the eighth embodiment assuming a schedule management system and a schedule reminder system to be an independent system, respectively. However, it may safely be said that the one system includes the other system.

Besides, the schedule reminder system of the present invention, as shown in FIG. 2, can be used as server software by connecting a client terminal 21 or 23 a user uses and a server 40 via a communication network 30 and providing each configuration module of the schedule reminder system in the server 40.

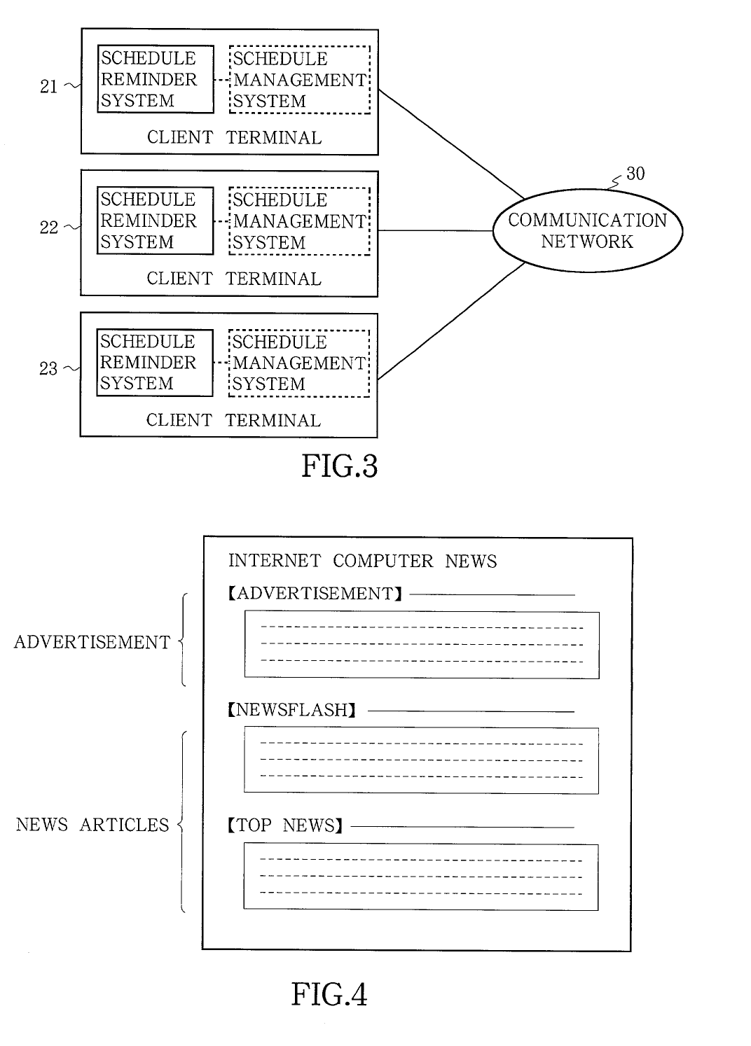

Otherwise, as shown in FIG. 3, the schedule reminder system of the present invention can apply as client software by providing each component module of the schedule reminder system at the side of a client terminal. Besides, in FIG. 2 and FIG. 3, as shown in the fifth embodiment or the eighth embodiment, when the schedule reminder system operates in cooperation with a schedule management system, the schedule management system will be provided in the same machine as the schedule reminder system. As shown in the first embodiment or the fourth embodiment, when the schedule reminder system operates singly, the schedule management system is unnecessary.

Further, using a recording medium on which these client software or server software are recorded, these scheduling reminder systems can be constructed and executed by being installed in a client terminal or server. The embodiments are described below.

### Ninth Embodiment

Next, a ninth embodiment of the present invention is described in detail with reference to the drawings.

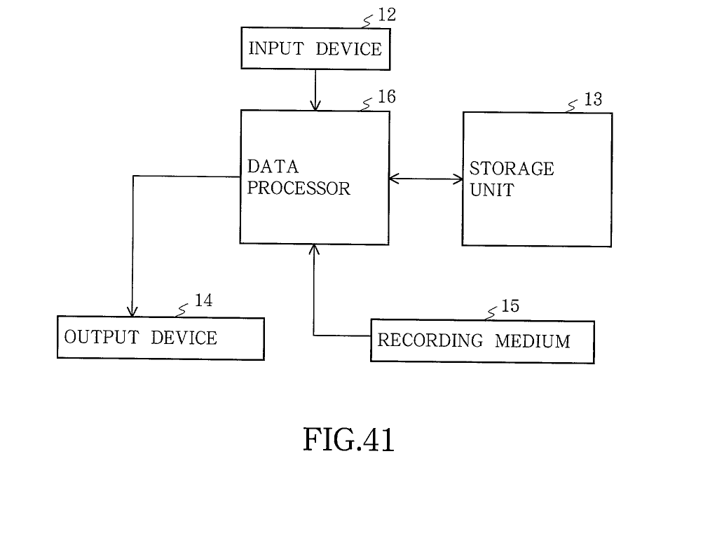

Referring to FIG. 41, the ninth embodiment of the present invention, in the same manner as the first embodiment of the present invention, comprises an input device 12, a data processor 16, a storage unit 13, and an output device 14, and, further comprises a recording medium 15 on which a scheduling reminder program is recorded. This recording medium 15 may be a magnetic disc, semiconductor memory, CD-ROM, or another recording medium.

The scheduling reminder program is read from the recording medium 15 in the data processor 16 and controls the operation of the data processor 16. Although not shown, the areas of a checklist template file and a message database are secured in the storage unit 13. The data processor 16 executes the same processing as the processing by a remind message registration portion and a message sending portion in the first embodiment by the control of the schedule reminder program.

### Tenth Embodiment

Next, a tenth embodiment of the present invention is described in detail with reference to the drawings. Referring to FIG. 41, the tenth embodiment of the present invention has the same configuration as the ninth embodiment of the present invention.

The scheduling reminder program is read from the recording medium 15 in the data processor 16 and controls the operation of the data processor 16. Although not shown, the areas of a checklist template file, a message database, and a keyword versus checklist interrelation table are secured in the storage unit 13. The data processor 16 executes the same processing as the processing by a remind message registration portion, a message sending portion, and a checklist selection module in the second embodiment by the control of the schedule reminder program.

### 11th Embodiment

Next, an 11th embodiment of the present invention is described in detail with reference to the drawings. Referring to FIG. 41, the 11th embodiment of the present invention has the same configuration as the 11th embodiment of the present invention.

The scheduling reminder program is read from the recording medium 15 in the data processor 16 and controls the operation of the data processor 16. Although not shown, the areas of a checklist template file, a message database, and a billing database are secured in the storage unit 13. The data processor 16 executes the same processing as the processing by a remind message registration portion, a message sending portion, and a billing module in the third embodiment by the control of the schedule reminder program.

### 12th Embodiment

Next, a 12th embodiment of the present invention is described in detail with reference to the drawings. Referring to FIG. 41, the 12th embodiment of the present invention has the same configuration as the ninth embodiment of the present invention.

The scheduling reminder program is read from the recording medium 15 in the data processor 16 and controls the operation of the data processor 16. Although not shown, the areas of a checklist template file, a message database, a billing database, and a keyword versus advertisement interrelation table are secured in the storage unit 13. The data processor 16 executes the same processing as the processing by a remind message registration portion, a message sending portion, a billing module, and an advertisement insertion portion in the fourth embodiment by the control of the schedule reminder program.

### 13th Embodiment

Next, a 13th embodiment of the present invention is described in detail with reference to the drawings. Referring to FIG. 41, the 13th embodiment of the present invention has the same configuration as the 13th embodiment of the present invention.

A scheduling reminder program is read from the recording medium 15 in the data processor 16 and controls the operation of the data processor 16. Although not shown, the area of a checklist template file is secured in the storage unit 13. The data processor 16 executes the same processing as the processing by a remind message registration portion and s schedule management system in the fifth embodiment by the control of the schedule reminder program.

### 14th Embodiment

Next, a 14th embodiment of the present invention is described in detail with reference to the drawings. Referring to FIG. 41, the 14th embodiment of the present invention has the same configuration as the ninth embodiment of the present invention.

The scheduling reminder program is read from the recording medium 15 in the data processor 16 and controls the operation of the data processor 16. Although not shown, the areas of a checklist template file and a keyword versus checklist interrelation table are secured in the storage unit 13. The data processor 16 executes the same processing as the processing by a remind message registration portion, a schedule management system, and a checklist selection module in the sixth embodiment by the control of the schedule reminder program.

### 15th Embodiment

Next, a 15th embodiment of the present invention is described in detail with reference to the drawings. Referring to FIG. 41, the 15th embodiment of the present invention has the same configuration as the ninth embodiment of the present invention.

The scheduling reminder program is read from the recording medium 15 in the data processor 16 and controls the operation of the data processor 16. Although not shown, the areas of a checklist template file and a billing database are secured in the storage unit 13. The data processor 16 executes the same processing as the processing by a remind message registration portion, a schedule management system, and a billing module in the seventh embodiment by the control of the schedule reminder program.

### 16th Embodiment

Next, a 16th embodiment of the present invention is described in detail with reference to the drawings. Referring to FIG. 41, the 16th embodiment of the present invention has the same configuration as the ninth embodiment of the present invention.

The scheduling reminder program is read from the recording medium 15 in the data processor 16 and controls the operation of the data processor 16. Although not shown, the areas of a checklist template file, a billing database, and a keyword versus advertisement interrelation table are secured in the storage unit 13. The data processor 16 executes the same processing as the processing by a remind message registration portion, a schedule management system, a billing module, and an advertisement insertion portion in the eighth embodiment by the control of the schedule reminder program.

### SUMMARY OF EMBODIMENTS

The schedule reminder system of the present invention describes necessary work items every type of a schedule event in a checklist template file. So a remind message can be sent at appropriate timing concerning not only a reminder for the schedule event itself, but also other related items.

Since a plurality of related work items can be described in a checklist temperate file, a different remind message can be sent at different timing one or more times.

Since the sending time of a checklist template file can be set at an optional time, a reminder message can be sent even at a later time than a schedule event.

An advertising copy can be contained in a reminder message. Since the advertising copy is contained in the reminder message, there is a low possibility that the advertising copy will be skipped. Further, since an advertisement is concerned with a schedule event entered by a user, and is distributed to the user at appropriate timing, it is expected that the efficiency of advertising is very high.

As described above, according to the present invention, a work item regarding a schedule event entered by a user can be reported to the user together. An advertisement is inserted in the schedule event of a user and the related work item and can be sent to the user. The advertisement is inserted in the schedule event of the user and the related work item and can be added to the calendar of a schedule management system.

What is claimed is:

1. A schedule reminder system having a template table where events are classified in accordance with various types and that holds one or more sets of remind messages in which work items regarding the schedule events are described and information about the timing at which each message is reported to a user, said schedule reminder system comprising:
remind message registration means for acquiring the remind message and information about the timing at which the message is to be reported from a template file of a corresponding event type based on a schedule event and its date entered by the user, and for obtaining a time at which a remind message is to be sent from the event date entered by the user and the timing information to be reported; and
message sending means for sending said remind message to the user at the sending time obtained by the above remind message registration means.

2. The schedule reminder system according to claim 1, further comprising a message database that can hold information about the message sending time obtained by said remind message registration means and a plurality of combinations of said remind message and a sending destination, wherein
said message sending means includes means of sending a remind message to the user of a sending destination referring to this database.

3. The schedule reminder system according to claim 1, further comprising advertisement billing means that counts the sending frequency of advertising every type of the advertisement and an advertisement billing database that holds the type of the advertisement and the sending frequency when an advertisement is contained in a remind message that is sent to the user.

4. The schedule reminder system according to claim 1, further an interrelation table that associates a keyword and an advertisement and advertisement insertion means that obtains a related advertisement from a keyword contained in a remind message referring to said interrelation table and adds an advertising copy to the remind message.

5. The schedule reminder system according to claim 1, further comprising an interrelation table that associates a keyword and a type of a schedule event and event type discriminating means that automatically discriminates the type of schedule event from schedule information entered by the user referring to said interrelation table.

6. The schedule reminder system according to claim 1, further including means that operates in cooperation with a schedule management system that displays a schedule of the calendar format and displays a remind message regarding a schedule event on the calendar of the schedule management system.

7. The schedule reminder system according to claim 1, wherein the user terminal the user uses and a server are connected via a communication network and each configuration means of the schedule reminder system is provided in said server.

8. The schedule reminder system according to claim 1, wherein a telephone or a facsimile system is used as message sending means.

9. The schedule reminder system according to claim 1, wherein electronic mail is used as message sending means.

10. The schedule reminder system according to claim 1, wherein communication means that uses a network line of a wireless or wired destination is used as message sending means.

11. The schedule reminder system, wherein communication means that can send character information to a specific time is used as message sending means.

12. A schedule reminder method that reports a plurality of related work items required for executing not only a schedule event itself, but also the relevant schedule event at a different time as each different remind message, to the user, when the date of the schedule event and an event type are specified.

13. The schedule reminder method according to claim 12, wherein a work item required after the relevant schedule event is also sent as a remind message at a later time than the date of the schedule event.

14. The schedule reminder method according to claim 12, wherein a remind message that contains an advertisement as a reminder of a schedule event is sent to the user and charges the relevant advertisement.

15. The schedule reminder method according to claim 12, wherein an advertisement is inserted in a remind message of a schedule event that contains no advertisement and charges the relevant advertisement.

16. The schedule reminder method according to claim 12, wherein a schedule reminder system that operates in cooperation with a schedule management system of the calendar format and displays a remind message on the calendar of the relevant schedule management system.

17. The schedule reminder method according to claim 12, wherein a remind message is reported to the user using a telephone or a facsimile system.

18. The schedule reminder method according to claim 12, wherein a remind message is reported to the user using electronic mail.

19. The schedule reminder method according to claim 12, wherein a remind message is reported to the user using a wireless or wired network line.

20. The schedule reminder method according to claim 12, wherein a remind message is reported to the user using communication means that can send character information at a specific time.

21. A schedule reminder method that reports a plurality of related work items required for executing not only the relevant schedule event itself, but also the relevant schedule event at a different time as each remind message, to the user, when the date of the schedule event is specified and a character string in which the contents of the event are described is assigned.

22. A schedule reminder method that sends a reminder message that contains an advertisement as a reminder that specifies a related work item required for executing a schedule event, to the user, and charges the relevant advertisement.

23. A schedule reminder method that inserts an advertisement in a reminder message that specifies a related work item required for executing a schedule event and charges the relevant advertisement.
